(19) United States
(12) Patent Application Publication
(10) Pub. No.: US 2016/0211038 A1
(43) Pub. Date: Jul. 21, 2016

(54) SHOCK-ABSORBING PROTECTION ELEMENT FOR PACKAGING FOR THE TRANSPORT AND/OR TEMPORARY STORAGE OF RADIOACTIVE MATERIALS

(71) Applicant: TN INTERNATIONAL, Montigny Le Bretonneux (FR)

(72) Inventor: Marie Houillon, Montigny Le Bretonneux (FR)

(73) Assignee: TN International, Montigny Le Bretonneux (FR)

(21) Appl. No.: 14/914,890

(22) PCT Filed: Sep. 8, 2014
(86) PCT No.: PCT/EP2014/069054

§ 371 Date: Feb. 26, 2016

(30) Foreign Application Priority Data
Sep. 6, 2013 (FR) 13 58586

(51) Int. Cl. G21F 5/08; B65D 81/02; B65D 81/05; F16F 7/12

(52) U.S. Cl. CPC G21F 5/08; F16F 7/121; B65D 81/022; B65D 81/051

(57) ABSTRACT

A protective shock absorbing element block made of rigid and brittle foam is provided with superficial or internal structure irregularities (20), having sharp edges in the foam to enable its immediate crushing by cracks propagating in depth throughout its entire volume, which facilitates its fragmentation with predicted characteristics. As a variant, a superficial hardening coating (28) could be used, to fill in the outer pores (27) in the foam, together with a lateral clearance with the envelope, or studs covering the inside of the envelope. Applies to shock resistant protective shock absorbing elements, particularly covering packagings exposed to drops.

The subject of the invention is a protective shock absorbing element with a solid block infill for a transport and/or temporary storage packaging for radioactive materials.

In the design of such packagings, it is necessary to take account of technical constraints dictated by regulatory safety requirements for the transport of radioactive materials. Tests to be performed to demonstrate that these regulatory requirements are respected include different tests like “free drop” tests, and particularly the 9-meter drop onto a rigid target.

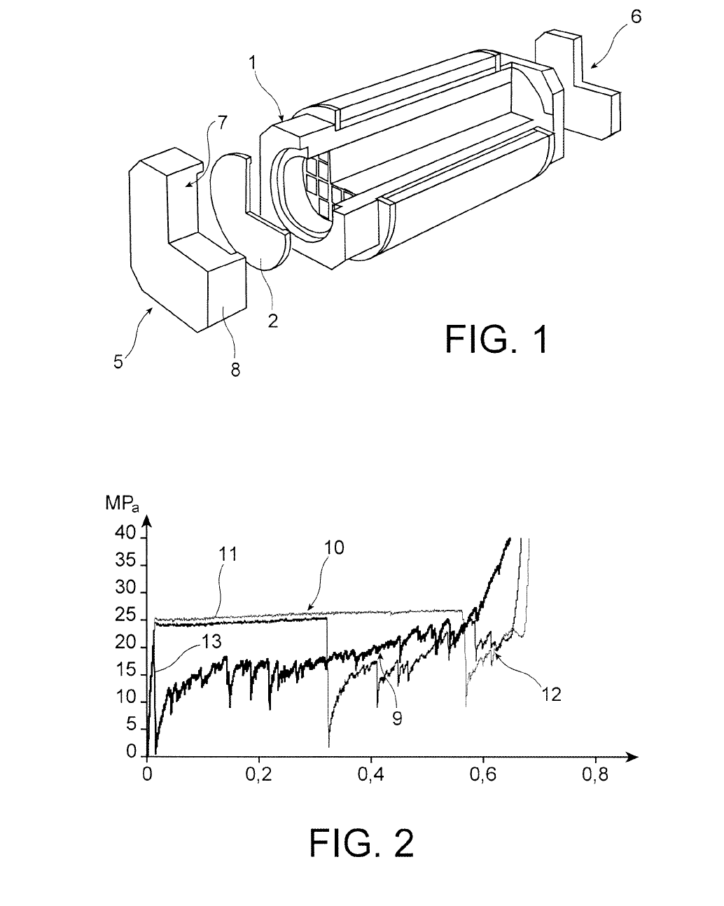

These packagings are frequently fitted with protective shock absorbing elements on their outer faces to prevent the consequences of such drops. In the packaging shown in FIG. 1, the main part of which is a hollow cylindrical body 1 fitted with cooling fins and that also includes a closing lid 2 on the body 1, there are also two protective shock absorbing elements 5 and 6 at the axial ends of the packaging, that cover the lid 2 and the bottom face of the body 1, and each of them comprises an infill 7, housed inside a casing 8 that is assembled to the body 1 by bolts or other attachment means.

The casing 8 must yield in the case of a shock and therefore makes a non-negligible contribution to energy absorption, but it also effectively holds the infill 7 in position on the packaging, while protecting it from minor external shocks.

The infill 7 is usually made of wood in conventional designs, and absorbs energy from shocks by crushing. Nevertheless wood, typically balsa, oak or red cedar has the disadvantage of being an orthotropic material and also has unstable mechanical properties that vary as a function of the temperature and humidity. Furthermore, shaping is complex due to the orientation of fibres.

Known materials for making the infill 7 could advantageously be replaced by carbon foam. Tests carried out have shown that carbon foam is an extremely high performance shock absorbing material, and its intrinsic properties make it perfectly suitable for use within a protective shock absorbing element for a radioactive material transport packaging. Thus, carbon foam can have high crushing stress of up to 20 MPa or more, and it can also have a maximum allowable crushing ratio of the order of 60%.

It is especially an isotropic material capable of optimising damping along the different load directions that might occur during axial, oblique or lateral drops.

Nevertheless, the inventors realised that there is a difficulty in characterising the crushing behaviour of carbon foam, and this characterisation is necessary for the design of packagings to satisfy regulatory drop tests. FIG. 2 thus shows a typical crushing curve for such an infill 7 marked with reference 9. It expresses the stress to be applied (in Megapascals, on the ordinate) to apply an increasing strain to the infill 7 (in relative values, on the abscissa). This curve usually increases fairly uniformly, and repetitively for different specimens. However, another shape of curve sometime occurs, shown by reference 10; this curve has a plateau 11 when subjected to a high stress level at the beginning of the compression, and this plateau 11 can continue to a high strain, after which strain continues at a suddenly lower stress, that can even be lower than the ordinary curve 9 with identical strain but then increases (portion 12).

The behaviour shown by curve 10 is undesirable. Admittedly, it represents the fact that the infill 7 absorbs more compression energy, at least as long as the plateau 11 continues, but is nevertheless undesirable because the width of the plateau 11 is unpredictable and design criteria for infill materials would then be uncertain. Furthermore, the initial stiffness of the foam might be accompanied by a modification to the ability to absorb shocks, despite the increased energy absorption.

After observing this phenomenon, the Inventors reached the following conclusions: the plateau 11 is the consequence of an initial peak 13, that expresses the frequently high stress necessary to cause the initial damage to the infill 7; this peak 13 often occurs, even in specimens with normal behaviour represented by the curve 9; but it is then very narrow, its effect is very small and the stress necessary to continue the strain reduces immediately, before increasing, while the stress value reached at the peak 13 continues to create the plateau 11, in the case of the curve 10. The Inventors observed that infills 7 with curve 9 were subject to early cracking of the foam through their entire depth, that caused fragmentation into increasingly smaller pieces until a powder is obtained, crushing the foam uniformly, which explains the more or less regular growth in strain under a moderately increasing stress; whereas the plateau 11 implies that damage remains superficial and limited to locations at which pressures are applied and corresponds to a metastable strain state, before the infill 7 returns to its normal in-depth cracking behaviour, in portion 12.

The purpose of the invention is to eliminate compression behaviours with purely superficial damage of such infills 7 made of carbon foam, and to assure that the behaviour shown in curve 9, repetitive for all infills 7, is guaranteed.

It should be noted that the compression mode that introduces surface damage represented by plateau 11 only occurs in the case in which the carbon foam infill is confined in a rigid casing, that can for example be made from a metallic material with a thickness that varies between 1 and 5 mm. Thus, if the foam infill is completely free, there is very little chance that the plateau 11 will occur. However, if it is required that a carbon foam infill should crush correctly at the time of the impact without being dislocated or escaping on the sides, the foam infill must necessarily be confined such that most of the infill can participate in energy absorption by strain. It should be noted that this difficulty does not necessarily arise with wood that is much less fragile than carbon foam.

Various measures can be taken in order to eliminate the compression behaviours described above. One measure consists of providing structural irregularities in the infill, consisting of one or several discontinuities of the foam, the foam delimiting the discontinuity(ies) by a section including a reentrant angle in the foam. A reentrant angle means an angle between 180° and 360° and preferably between 270° and 350°. In other words, the discontinuity includes at least one portion that is tapered as far as an end forming a sharp projecting angle in the foam. The dimensions of the irregularities must be equal to at least five times a maximum diameter of pores in the foam, as will be described in detail later, but they may also be made at any location in the infill, in other words on the face on which the impact occurs, on the opposite face adjacent to the protected packaging, on the side faces or even inside the infill. In this respect, it could be specified that the face on which the impact occurs does not have to be perfectly perpendicular to the direction of application of impact forces for the invention to function. It is also remarkable that the favourable effect of the irregularities occurs even if the hollows that they form are closed off by plugs made of the same foam when it is required to restore the volume of the infill and its energy absorption capacity, because the structural discontinuity remains. In all situations, a crack leading to a rupture occurs in the foam structure at the location of the angle that forms the discontinuity, and this crack guarantees that the carbon foam infill immediately has the required behaviour according to curve 9. It should be noted that other shape or structural irregularities that do not have a reentrant angle in the foam, would not create a sufficient stress concentration to cause cracking. Thus, through holes with a circular cross section, for example drillings inside which infill attachment rods are fitted, do not have such angles and therefore are not suitable. The same applies for example for holes with a rounded bottom. Furthermore, and as mentioned above, the technical problem specific to the invention exists only for rigidly encased infills, in principle the behaviour represented by curve 10 does not occur for infills exposed on the outer face and therefore subject to direct impacts.

Alternatively, the internal surface of the casing could be provided with an excroissance with a section forming a projecting angle. The inner surface of the casing on which the excroissance is formed faces the outer surface of the casing exposed to impacts. The excroissance then typically performs the same role as the discontinuity in the foam at the time of the impact, a crack leading to rupture occurring in the foam structure when the excroissance impacts the infill.

Another method would be to coat the face of the foam exposed to impacts with a hardening coating. This could be done by filling in the open pores with a coating or a superficial incrustation of a material that can harden on this surface over a given thickness. Superficial damage will no longer occur easily, so that cracking of the foam will develop immediately in depth.

In yet another method, a non-negligible clearance is left between the peripheral face of the infill and the casing, in order to tolerate its peripheral expansion when compression begins, so that internal decohesion of the material can occur, that initiates in-depth cracking. The infill is then placed inside the casing in the form of a prefabricated block, after having been machined to the required dimensions. Therefore, the infill is not injected into the casing as may be the case for some other types of foam, such as phenolic foam.

In yet another method in which the shape and structure of the infill may be perfectly regular, the initiating rupture is caused by one or several excroissances that project from the inner face of the casing towards the surface of the infill, and that penetrate into it when the casing is indented by an impact.

Therefore, materials to which the invention can be applied are carbon foams with a porous structure, with open or closed pores. It should be noted that carbon foam is a rigid brittle material, in other words it can break with almost no plastic strain. Foams may have a porosity of at least 50%, so that they have a sufficient crushing height.

Recent prior art includes U.S. Pat. No. 5,394,449 A that discloses a foam infill through which drillings are formed without any sharp reentrant angles into the foam and are therefore unsuitable for generating the properties of the invention; FR 2 971 615 A that discloses quasi-spherical foam blocks without any rigid casing; and JP 01 124799 A that discloses a foam into which a polymer or ceramic is injected, but the foam is metallic.

The invention will now be described with reference to the figures that illustrate its various aspects and result in some embodiments that are not exclusive of the others:

FIG. 1 is a general view of a packaging for transport and/or temporary storage of radioactive materials, on which the invention could be used;

FIG. 2 expresses the phenomenon concerned, and

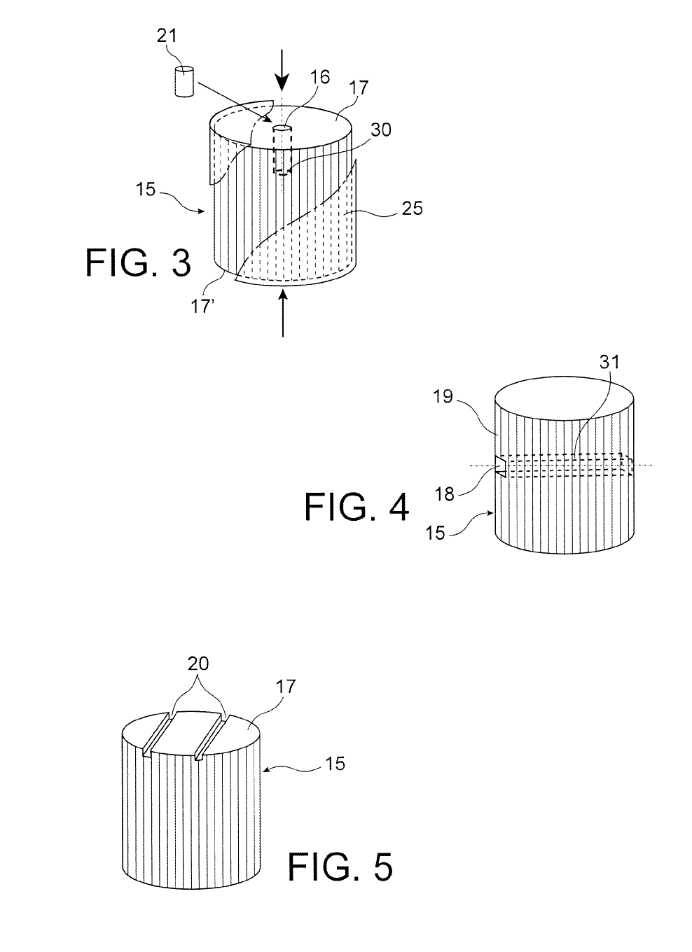

the remaining FIGS. 3, 4, 5, 6, 7, 8, 9, 10, 11, 12, 13, 14, 15, 16, 17, 18, 19 and 20 illustrate various embodiments of the invention.

FIGS. 1 and 2 have already been described, therefore refer directly to FIG. 3. This figure shows an infill 15 of a protective shock absorbing element, in the form of a solid cylindrical block that can be compressed by forces orthogonal to the face 17 on which the impact will be applied. It should be noted that in this special case, the face exposed to the impacts 17 and the opposite face 17′ adjacent to the packaging are plane and parallel to each other. Applied forces are shown by arrows in FIG. 3. The invention includes the case in which the regular shape of the cylinder is interrupted by a hole 16 that in this embodiment is drilled in the impact face 17. This irregularity in the shape or structure prevents the plateau 11 from occurring and guarantees that the reaction of the infill 15 to shocks will be as shown in curve 9 in FIG. 2. The hole 16 may be any shape. However, it should not pass through the infill 15 from one side to the other, if it is hollowed out along the direction in which the forces are applied, as it is in this case. If the invention is to function correctly, it is essential that the infill 15 forms a sharp reentrant angle with the hole 16, which in this case is obtained at the bottom edge 30 at the bottom of this hole perpendicular to (or more generally intersecting) the direction of the impact force. The reentrant angle in this case is equal to about 270°. This is the location at which a crack will occur in case of impact due to the stress concentrations that occur at this location and that will immediately propagate to the rest of the structure, causing its destruction by crumbling so that it can fulfil its energy absorption role. A rounded bottom of the hole 16, for example hemispherical, would not be suitable. An edge with a sharp angle located parallel to the direction of the impact force could also be inadequate because no significant stress concentration would occur; therefore, it is not considered to be relevant to the invention. It is recommended that the dimensions of hole 16 should be at least about five times the size of the largest spherical pores in the foam. It should be noted that the hole is not necessarily located on the impact face 17; FIG. 4 illustrates another embodiment in which the hole 18 is formed on the peripheral face 19 of the cylinder; the effect is the same. The hole 18 is shown as a through hole, but this is not critical in this case. However, it is necessary that the cross-section of the hole 18 should be polygonal, for example square, in such a situation, so that there are edges 31 forming reentrant sharp angles in the infill 15 so that once again, stress concentration zones exist in cases of impact, that could initiate cracking and failure. It should be noted that after holes 16 or 18 have been machined, they can be closed off by means of a plug 21 in FIG. 3, that is put into position after the hole 16 has been machined. The initial volume of the infill 15 and its shock absorbing efficiency are thus restored, without the risk of the curve 10 with plateau 11 occurring. In this embodiment, as in the others, the infill 15 is covered by a rigid casing 25 that is only partly shown in this case. The casing 25 is not shown in most figures for reasons of clarity. It surrounds the infill 15 either completely, or only at faces opening outwards. When it completely surrounds the infill 15, the protective shock absorbing element may be removable and independent from the remainder of the packaging. It can be 2 mm thick, so that it can deform during an impact to enable crushing of the infill 15, despite its stiffness at low forces, while guaranteeing lateral confinement of the foam.

Structural irregularities should be created at a sufficient depth to impose damage beyond the impact face 17 on which the shock pressure is applied and the opposite face to which the resisting reaction pressure is applied, and in zones in compression. Therefore holes such as holes 16 formed on one of these faces need to be deep enough to satisfy the first criterion and their cross-section must be large enough to create a sufficiently large discontinuity to produce the necessary stress concentration, which is the reason for the above design criteria. The cross-section and the depth of holes such as holes 18 formed on the peripheral face 19 must be large enough to create stress concentrations; in practice, they may be longer than holes 16 (which is the reason for the suggested through holes 18, although this is not essential) to be able to absorb local shocks on a peripheral portion of the infill 15 at a distance from the holes 18, because the surroundings of the holes would then only be slightly stressed.

FIG. 5 illustrates a slightly different embodiment that shows that the holes 16 or 18 may be replaced by one or several grooves 20, in this case formed in the impact face 17, although this condition is not necessary either, because grooves in the peripheral face 19 would have the same effect. The design criteria are similar; the cross-section of the grooves 20 must be large enough so that sufficiently high stress concentrations occur and penetrate under the surface layer of the impact face 17 or the opposite face. Its dimensions may be at least five times the diameters of the largest pores in the foam, and preferably 10 times. The grooves are long enough so that they extend to locations at which even local shocks are applied with more certainty.

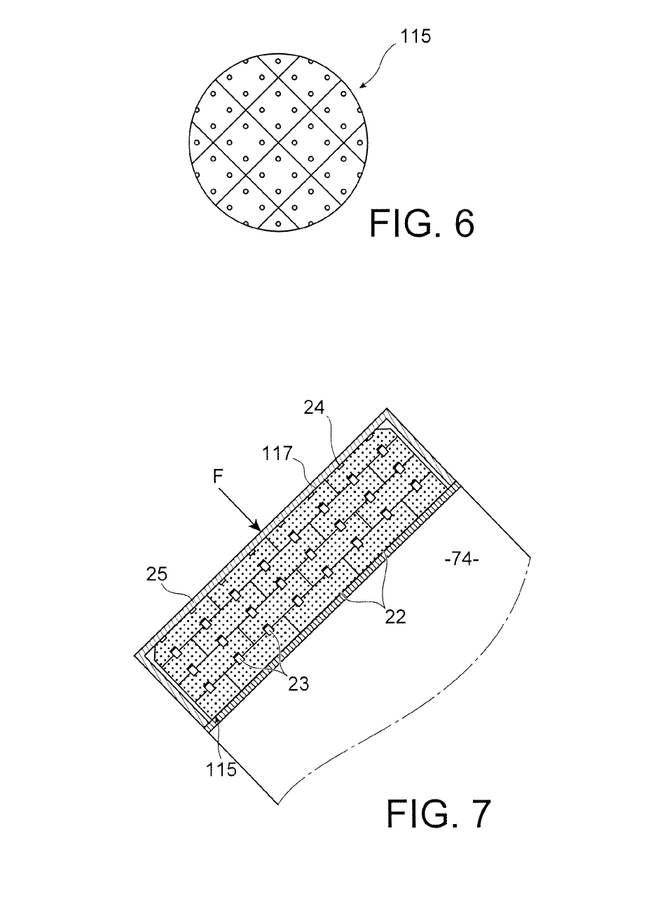

Another embodiment is shown in FIGS. 6 and 7. The infill is marked as reference 115, and it comprises four successive layers. Each layer is built up from smaller blocks 22 assembled in layers, through connecting elements that may be in the form of pins 23 that may be also made from a foam with the same composition or from another material, extending from one layer of blocks 22 to the other. A single-piece assembly is formed since the blocks 22 are arranged staggered in different layers. Holes 24, similar to holes 16, are formed on the outer surface of the infill 115, on the side of the impact face 17, in the same way as form the embodiment in FIG. 3. In this case, holes 24 form a lattice and are uniformly distributed, one being present on each block 22 of the upper layer. The holes in which pins 23 fit can initiate in-depth damage to the foam in each block 22. Due to the configuration of the holes in which pins 23 fit, it should be noted that the blocks 22 forming the three last layers starting from the packaging side, each comprise at least one discontinuity on each of the faces exposed to impacts and opposite faces adjacent to the packaging. More generally, the same effect of creating stress concentrations and in-depth cracking can be obtained using inclusions with any shape and material inside the foam provided that a structural discontinuity according to the invention is created and that it is large enough (always at least five times the diameter of the largest pores in the foam, but preferably at least ten times).

We will now give some examples developing the above concepts.

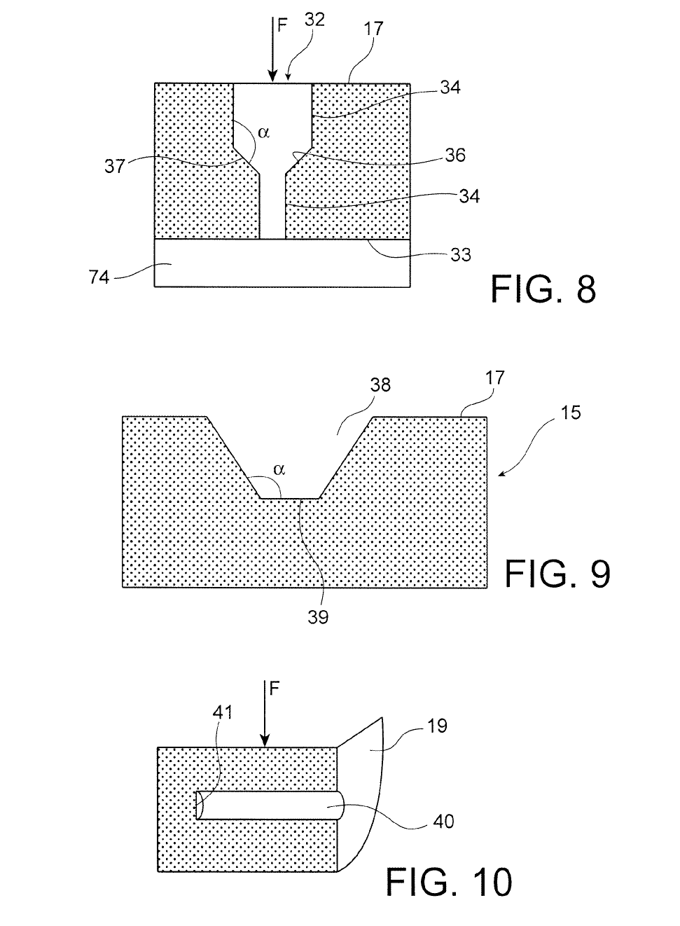

In FIG. 8, a hole 32 extends from the impact face 17 as far as the opposite face 33 adjacent to the packaging in case of transport, or temporary storage to be protected. This through hole 32 has a large cross-section 34, connected to a narrower cross-section 35 through a conical chamfer 36. This chamfer leading to the largest section 34 is the means by which the invention is implemented due to the edge 37.

In FIG. 9, the infill 15 comprises a conical flat bottomed non-through hole 38, in which crack initiation will occur at edge 39, between this bottom and the conical main wall of the hole 38. This edge defines a reentrant angle in the foam equal to about 220°, characteristic of the discontinuity according to the invention.

In general, the orientation of these holes may be arbitrary, opening up equally well at the impact face 17, or at the opposite face 33, or at the peripheral face 19. This is illustrated by the embodiment in FIG. 10 that comprises a non-through hole 40 with a circular cross-section, opening up on the peripheral face 19; the shape of the hole 40 is similar to the shape of the hole 16 in FIG. 3, in particular it has a flat bottom and therefore a sharp angle with a bottom edge 41 that will create the required cracking.

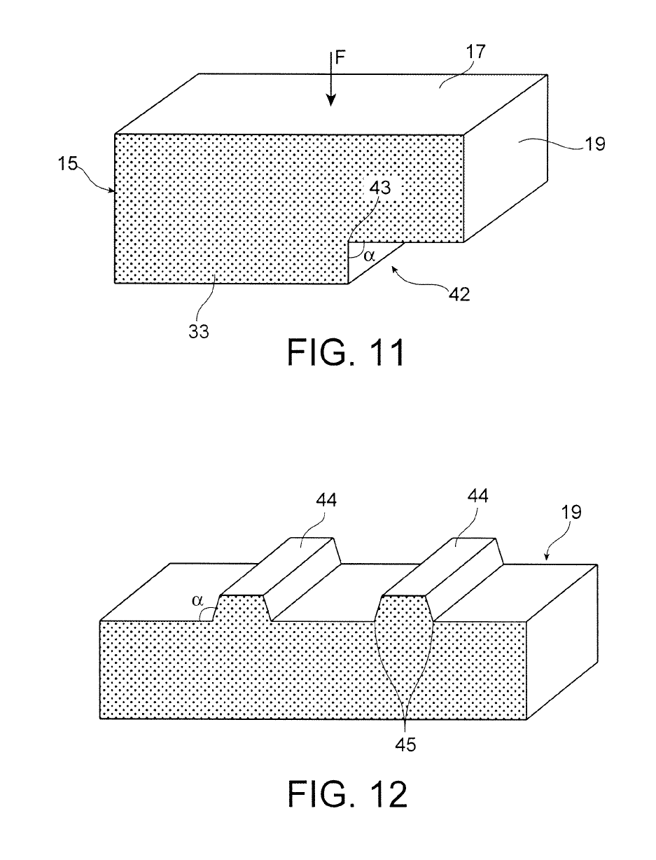

The embodiment in FIG. 11 shows another arrangement in which the irregular shape consists of a notch 42 formed in a corner of the infill 15. Once again, the notch has a sharp angle and it forms an edge 43 in the infill 15 at which the crack will develop. In this case, the notch 42 opens up on the opposite face 33 and also on the side face 19, although this is not necessary.

The embodiment in FIG. 12 is similar to the embodiment in FIG. 5, except that the grooves 20 that were described are replaced by projections 44 projecting from the impact face 19 as shown in this case, or from the opposite face 33. The connections of the projections 44 to the face concerned are edges 45 with sharp angles, still capable of initiating cracking. These edges 45 are used to define a reentrant angle in the foam equal to about 270°. Allowable irregularities are also composed of arbitrary shaped relief, created by any possible process, and particularly any machining process forming voids left empty or occupied by inclusions, provided that the cracking edge is created.

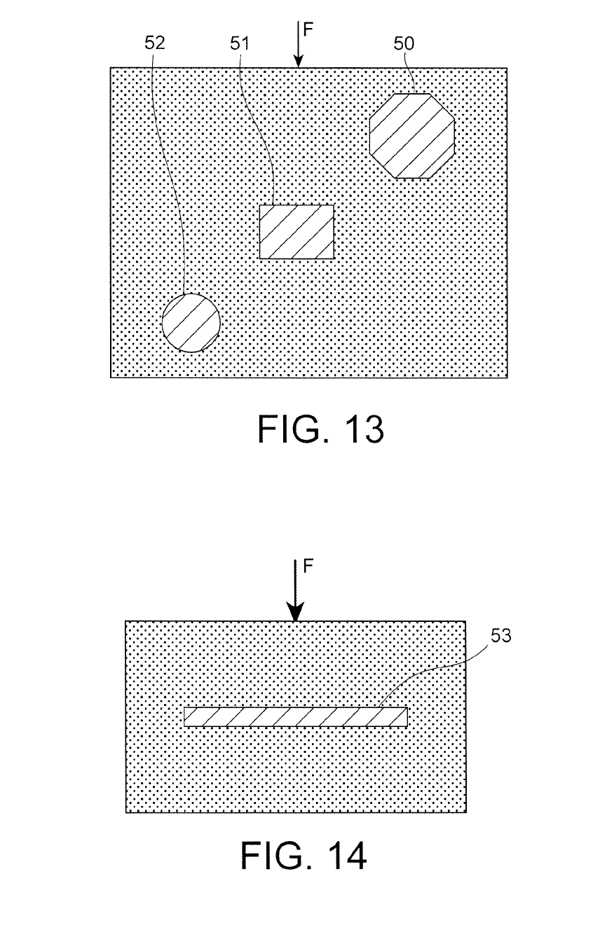

The embodiment in FIG. 13 illustrates solid inclusions with different allowable shapes embedded into the infill 15; a polygon 50 with several facets, a cube 51, or a sphere 52 without a cap.

FIG. 14 illustrates a bar 53 like the other inclusions embedded into the infill by insert moulding.

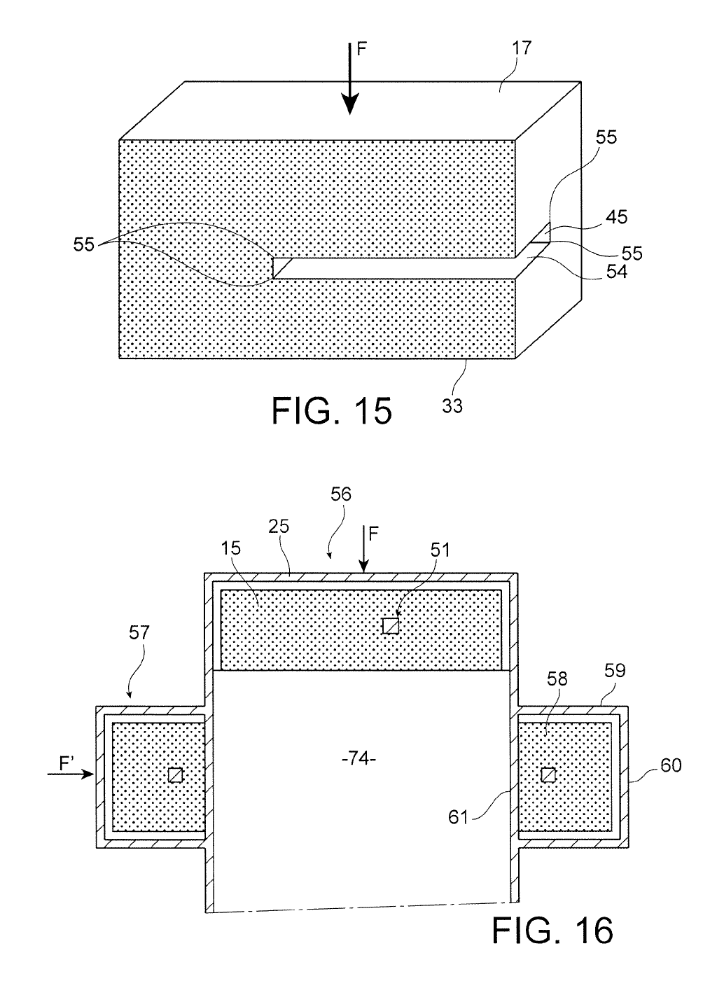

In the embodiment in FIG. 15, the shape irregularity is a notch 54 formed on the peripheral face 19, with an indent perpendicular to the direction in which impact forces are applied. The edges 55 that initiate cracking appear at the bottom of this notch 54, obviously provided that it is not rounded.

Refer to FIG. 16, that illustrates that the protective element is not necessarily an element placed at the top of the packaging 74; in this embodiment, in addition to a protective top element 56 comprising a casing 25 and an infill 15 conforming with the above (for example an inner cubic inclusion 51), there is an annular shape side protective element 57, surrounding the packaging 74, that may be constructed based on the above principles and may therefore form part of the invention; it then comprises an annular infill 58 and an annular casing 59 surrounding the infill 58, and once again sufficiently large structural irregularities such as holes, notches or inclusions conforming with the above criteria. In this case, the impact face considered is the outer face 60 of the casing 59, the opposite face will be the face opposite to the packaging 74, in other words the inner face 61, and the plane faces will act as the peripheral face 19 in the embodiments considered above. The front impact force similar to what has been considered in the above embodiments is denoted F, while the lateral impact force that justifies the annular infill 58 is denoted F′.

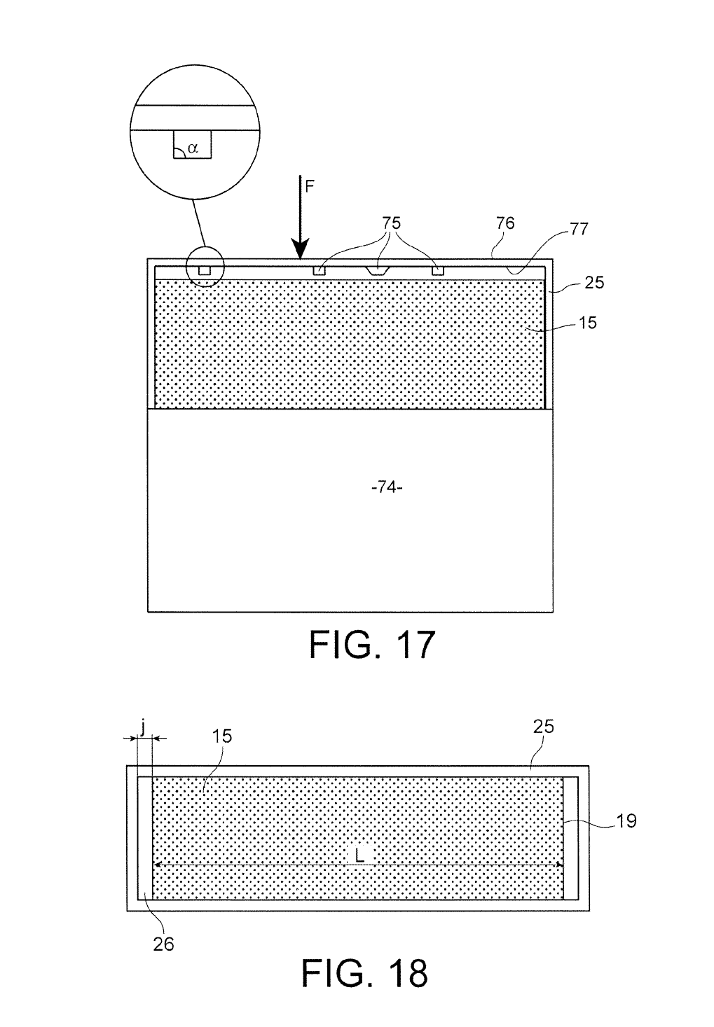

Another measure also contributes to eliminating the possibility for the plateau 11 to occur, and can be used alone, namely an infill 15 with a perfectly regular shape or structure (FIG. 17). The protective casing 25 of the infill 15 comprises at least one excroissance 75 on its inner face that may for example at least be in the form of a stud. This excroissance 75 thus comprises a projecting section that will initiate a break in the inside volume of the infill 15 when the excroissance 75 strikes it. The inner face 76 of the casing 15 comprising the excroissance is located facing the outer surface 77 of the casing exposed to impacts. When an impact is applied to the casing 25, the casing is indented and the excroissance(s) 75 penetrate(s) into the infill 15 and initiates a notch. The excroissance 75 is preferably cylindrical, conical or tapered towards the infill 15. Its dimensions must then be sufficient to cause damage to initiate a rupture in the complete infill 15, according to the above criteria. The excroissance(s) 75 is (are) not in contact with the infill 15 before the impact.

Another embodiment also contributes to eliminating the possibility of the plateau 11 from occurring, to the extent that it can be used alone, on an infill 15 in which the shape or structure is perfectly regular (FIG. 18). There is a peripheral clearance 26 between the protective casing 25 and the infill 15, instead of it being a tight fit as is the usual case. The casing 25 is preferably metallic but it could also be made of a composite material, particularly a material based on carbon fibres. When an impact occurs, the material of the infill 15 is capable of deforming by radial expansion, which enables the development of in-depth cracks by decohesion of the material. A regular clearance equal to j between the peripheral face 19 and the casing 25 equal to 0.1 to 5% of the width L of the infill 15 between two opposite portions of the peripheral face 19 is possible to obtain the required effect. The infill 15 may be held in position at the centre of the casing 25, for example by spacer rings.

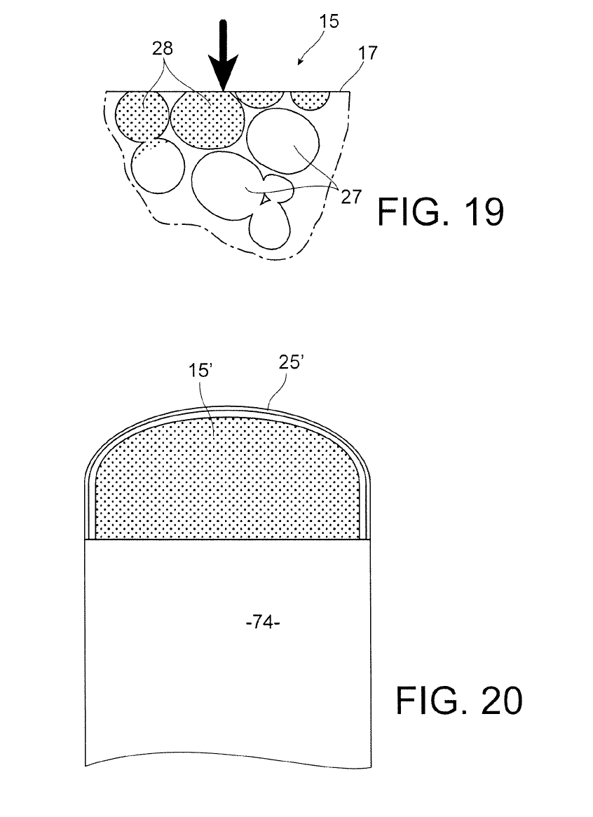

Another embodiment is shown in FIG. 19, that illustrates a detail of an infill such as 15 represented above but for which the shape and structure may be perfectly regular. The foam is composed of a honeycomb structure comprising pores 27, essentially spherical, with a large diameter and that may be opened or closed. The pores 27 opening up on the outside of the infill 15 are derived from machining operations previously carried out on the infill before it is inserted into the casing. The embodiment involved here consists of partly or completely filling in the large pores 27 located on the surface by applying a coating, an incrustation or more generally a hardening coating 28. The pores 27 opening up on the outside of the infill 15, and especially on the impact face 17 and possibly on the resisting pressure face, are considered. Varnish and graphite have been used successfully. This coating also has lubricating properties which can be useful in some applications, in which friction is applied to the infill 15. The surface layer of the infill 15 is reinforced by the hardened coating 28, therefore the first damage takes place further inwards, between the pores 27 that are left empty. Propagation of damage inside the foam is facilitated in the case of impact, which contributes to creating crushing conforming with predictions, once again preventing the plateau 11 in FIG. 2. The pores 27 disclosed in this invention are large open or closed essentially spherical pores, for which the diameter may typically be 1 mm; these large pores 27 govern design criteria for the external or internal irregularities seen above with reference to FIGS. 3 to 16. The foam also comprises lattices of smaller pores with diameter between 10 μm and 100 μm that form a continuous lattice but that are not shown here and do not play any direct role in the invention.

In general, the characteristics of the embodiments disclosed herein may be combined in a single infill.

Finally, there is no need for the impact face nor for the opposite face adjacent to the packaging 34 to be plane, as has already been seen with reference to FIG. 17; FIG. 20 illustrates yet another possibility for a protective element at the top of the packaging 34 with the impact face 17′ in the form of a convex cap, covered with a casing 25′ with the same convex shape. The above requirements for the invention may be applied.

What is claimed is:

1-17. (canceled)

18. Protective shock absorbing element for a transport and/or temporary storage packaging for radioactive materials, said element comprising a solid infill (15) made of rigid and brittle foam, a rigid casing (25) covering the infill, characterised in that the foam is a carbon foam, and the infill has a foam discontinuity between a face (17) exposed to impacts and an opposite face (74) adjacent to the packaging, the discontinuity having dimensions equal to at least five times a maximum diameter of the foam pores, the foam delimiting the discontinuity by a section comprising a reentrant angle in the foam.

19. Protective shock absorbing element according to claim 18, characterised in that the discontinuity is an empty volume.

20. Protective shock absorbing element according to claim 18, characterised in that the infill is machined.

21. Protective shock absorbing element according to claim 18, characterised in that the discontinuity is a volume occupied either by a carbon foam plug separate from the infill, or by a solid inclusion.

22. Protective shock absorbing element according to claim 18, characterised in that the discontinuity is present either on the face exposed to impacts or on the opposite face.

23. Protective shock absorbing element according to claim 18, characterised in that the infill comprises a plurality of solid prefabricated blocks made of carbon foam.

24. Protective shock absorbing element according to claim 23, characterised in that each solid block comprises at least one discontinuity.

25. Protective shock absorbing element according to claim 22, characterised in that the face exposed to the impacts and the opposite face are plane and parallel.

26. Protective shock absorbing element according to claim 18, characterised in that the discontinuity is formed by machining.

27. Protective shock absorbing element for a transport and/or temporary storage packaging for radioactive materials, said element comprising a solid infill (15) made of rigid and brittle foam, a rigid casing (25) covering the infill, characterised in that the foam is a carbon foam, and the infill has a hardening coating (28), at least on the face exposed to impacts.

28. Protective shock absorbing element according to claim 27, characterised in that the hardening coating fills the pores (27) in the foam.

29. Protective shock absorbing element for a transport and/or temporary storage packaging for radioactive materials, said element comprising a solid infill (15) made of rigid and brittle foam, a rigid casing (25) covering the infill, characterised in that the foam is a carbon foam, and in that the protective element comprises a clearance (26) between the envelope and a peripheral face of the infill connecting the face exposed to impacts to the opposite face.

30. Protective shock absorbing element according to claim 29, characterised in that the peripheral clearance is between 0.1% and 5% of the width of the infill between two opposite portions of the peripheral face.

31. Protective shock absorbing element for a transport and/or temporary storage packaging for radioactive materials, said element comprising a solid infill (15) made of rigid and brittle foam, a rigid casing (25) covering the infill, characterised in that the envelope is provided with an inner face, oriented towards the infill, with at least one excroissance (75).

32. Protective element according to claim 31, characterised in that the excroissance is either cylindrical, conical or tapered.

33. Protective element according to claim 31, characterised in that the infill (15) has a regular structure, and the excroissance (75) is separated from the infill by a clearance.

34. Transport and/or temporary storage packaging (74) for radioactive materials, characterised in that its surface is provided with at least one protective shock absorbing element according to claim 18.
